(19) United States
(12) Patent Application Publication
(10) Pub. No.: US 2018/0106555 A1
(43) Pub. Date: Apr. 19, 2018

(54) TUBE WITH A RESERVOIR OF PHASE-CHANGE MATERIAL FOR A HEAT EXCHANGER

(71) Applicant: Valeo Systemes Thermiques, Le Mesnil Saint-Denis (FR)

(72) Inventors: Sylvain Moreau, La Suze Sur Sarthe (FR); Frédéric Tison, La Suze Sur Sarthe (FR); François Busson, La Suze Sur Sarthe (FR); Lionel Robillon, La Suze Sur Sarthe (FR)

(73) Assignee: Valeo Systemes Thermiques, Le Mesnil Saint-Denis (FR)

(21) Appl. No.: 15/566,870

(22) PCT Filed: Apr. 18, 2016
(86) PCT No.: PCT/EP2016/058584

§ 371 Date: Oct. 16, 2017

(30) Foreign Application Priority Data
Apr. 16, 2015 (FR) 1553381

(51) Int. Cl. F28D 20/02; F28F 3/04; F28F 21/06; B60H 1/00; F28D 1/03

(52) U.S. Cl. CPC F28D 20/025; F28F 3/046; F28F 21/067; F28D 2020/0008; B60H 1/005; F28D 1/0333; F25B 2339/022; B60H 1/00335

(57) ABSTRACT

The present invention relates to a tube with a reservoir of phase-change material (1) comprising:
two flow plates (3) configured to be assembled with one another,
at least one reservoir plate (5) being configured to be assembled onto an external face of one of the two flow plates (3) so as to form housings,
   said tube with a reservoir of phase-change material (1) further comprising a filling duct (200), said filling duct (200) being formed, on the one hand, by a filling spout (201) of the reservoir plate (5) towards the outside and, on the other hand, by the external face of one of the two flow plates (3), said filling duct (200) further comprising a plug (210), said filling duct (200) and said plug (210) being contained within a volume of width smaller than or equal to the width of the tube with a reservoir of phase-change material (1) and of height less than or equal to the height of the housings.

The present invention relates to a tube with a reservoir of phase-change material for a heat exchange bundle of a heat exchanger, in particular in the field of thermal management inside a motor vehicle.

Heat exchangers generally comprise a bundle of parallel tubes formed by plates containing a first heat transfer fluid, for example a coolant in the case of an evaporator of an air-conditioning circuit. The bundle is also traversed by a second heat transfer fluid, for example an airflow intended for the passenger compartment, said airflow passing over the tubes, the surface thereof which is increased by the addition of disrupters or inserts between the tubes optimizing the heat exchange.

It is known to provide these heat exchangers with reservoirs of phase-change material associated with the tubes of the bundle serving for the flow of the first heat transfer fluid. Such exchangers, for example in the case of an evaporator of an air-conditioning circuit, permit the cooling of a passenger compartment of the vehicle to be maintained during a given period of time, in particular when the engine of the vehicle is stopped and no longer drives the compressor for circulating the coolant, in particular for vehicles provided with an automatic stop-start engine system when the vehicle stops for short periods of time. In these periods when the engine stops, the phase-change material harnesses the calorific energy in the air passing through the evaporator in order to cool the air.

Thus, in particular, an evaporator for a vehicle air-conditioning circuit is known, said evaporator comprising a heat exchange bundle provided with a set of tubes for the circulation of the coolant, a reservoir for storing phase-change material being attached to the tubes and a passage for air being provided between the tubes and the cold storage reservoirs, in particular by protrusions and recesses formed therebetween. In such exchangers, the thermal transfer between the tubes in which the coolant flows and the reservoirs of phase-change material is reduced, on the one hand, by the existence of said protrusions and recesses extending over a large surface of each of the tubes and, on the other hand, by the thickness of material involved in the heat transfer from the tube to the reservoir. More specifically, this thickness comprises the wall of the tube and the wall of the reservoir.

One of the objects of the present invention is to remedy at least partially the drawbacks of the prior art and to propose a tube with a reservoir of phase-change material which is improved for more efficient use inside a heat exchange bundle of a heat exchanger.

The present invention thus relates to a tube with a reservoir of phase-change material for a heat exchange bundle of a heat exchanger, said tube with a reservoir of phase-change material comprising:
two flow plates configured to be assembled with one another in a sealed manner and to form at least one conduit in which a first heat transfer fluid flows,
at least one reservoir plate, said reservoir plate being configured to be assembled in a sealed manner onto an external face of one of the two flow plates so as to form housings for the phase-change material,
   said tube with a reservoir of phase-change material further comprising a filling duct for the phase-change material, one end of said filling duct opening into one of the edges of said tube with a reservoir of phase-change material, said filling duct being formed, on the one hand, by a filling spout of the reservoir plate towards the outside and, on the other hand, by the external face of one of the two flow plates, said filling duct further comprising a plug, said filling duct and said plug being contained within a volume of width smaller than or equal to the width of the tube with a reservoir of phase-change material and of height less than or equal to the height of the housings of the phase-change material.

As a result, the filling duct does not exceed in terms of width or height the tube with a reservoir of phase-change material. Thus, when said tube with a reservoir of phase-change material is incorporated inside a heat exchange bundle, the filling duct does not protrude and is not an encumbrance.

According to one feature of the invention, the filling duct comprises a stop.

According to a further feature of the invention, the plug is produced in metal.

According to a further feature of the invention, the flow plates and the reservoir plate are made of metal and fixed together by brazing, said metal plug also being fixed during the brazing of said plates together.

According to a further feature of the invention, the plug is produced from elastomer or plastics material.

According to a further feature of the invention, the plug is of a size greater than that of the filling duct so as to be compressed inside said filling duct.

According to a further feature of the invention, the filling duct comprises a retention tongue which is folded back onto the end of said filling duct opening into one of the edges of the tube with a reservoir of phase-change material.

According to a further feature of the invention, the retention tongue is made of the same material as the reservoir plate.

According to a further feature of the invention, the plug comprises a filling orifice.

According to a further feature of the invention, when it is folded back, the retention tongue covers the filling orifice of the plug.

According to a further feature of the invention, the retention tongue comprises a projection designed to be inserted at least partially into the filling orifice of the plug when said retention tongue is folded back.

According to a further feature of the invention, the tube with a reservoir of phase-change material comprises a filling and sealing compound between the filling spout of the reservoir plate and the plug.

Further features and advantages of the invention will appear more clearly from reading the following description, which is given by way of illustrative and non-limiting example, and the accompanying drawings, in which:

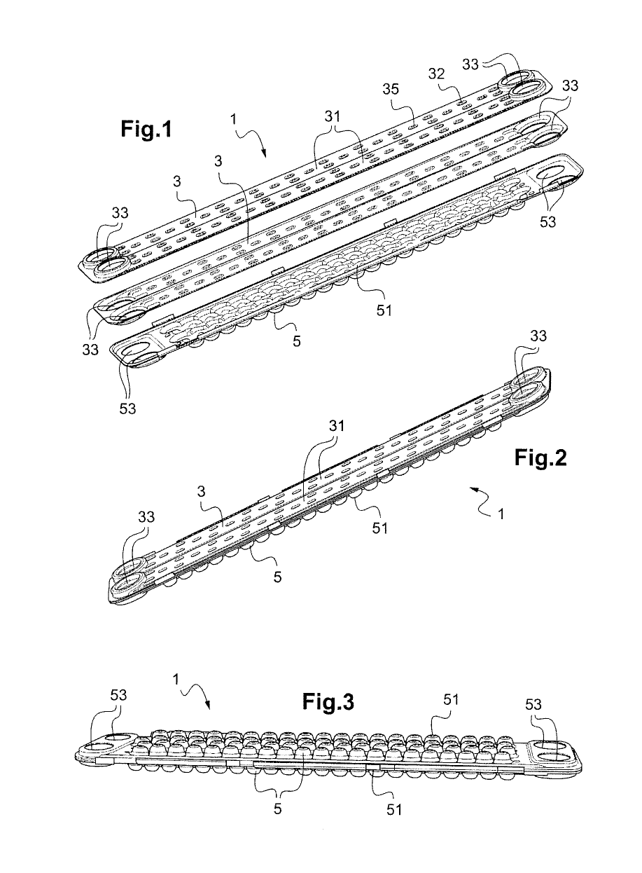

FIG. 1 shows an exploded schematic perspective view of a tube with a reservoir of phase-change material,

FIG. 2 shows a schematic perspective view of the tube with a reservoir of phase-change material of FIG. 1 in the assembled state,

FIG. 3 shows a schematic perspective view of a tube with a reservoir of phase-change material according to one particular embodiment,

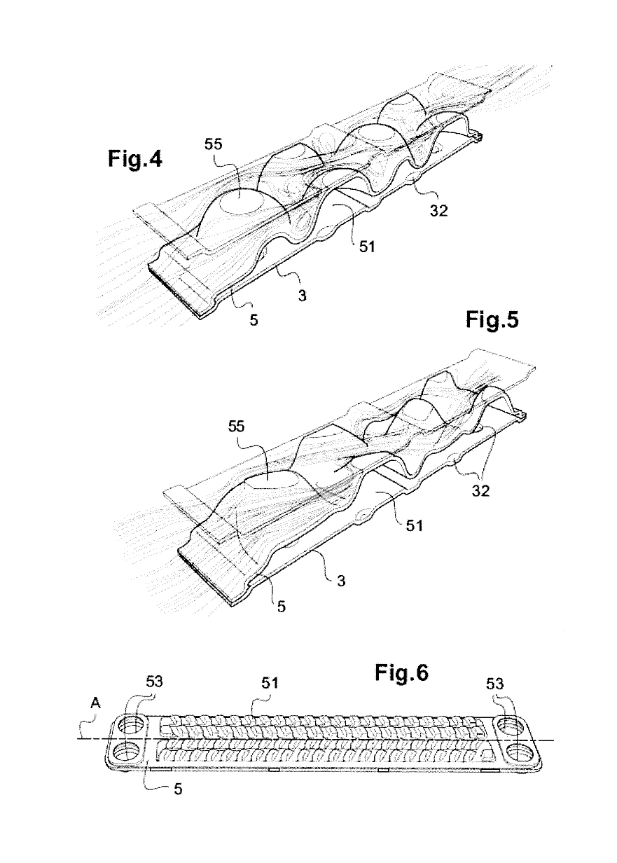

FIG. 4 shows a schematic view in section of a portion of the tube with a reservoir of phase-change material,

FIG. 5 shows a schematic sectional view of a portion of the tube with a reservoir of phase-change material according to a further embodiment,

FIG. 6 shows a schematic perspective view of a tube with a reservoir of phase-change material according to the embodiment of FIG. 5,

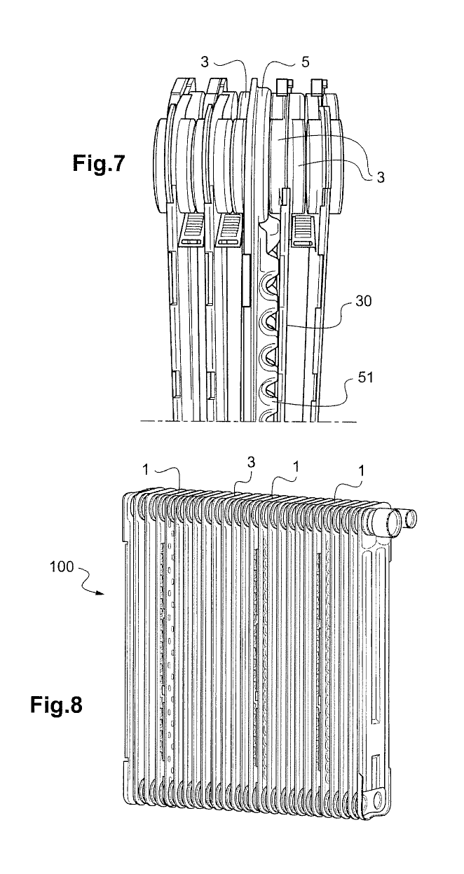

FIG. 7 shows a schematic perspective view of a set of tubes in a heat exchange bundle,

FIG. 8 shows a schematic view of a heat exchange bundle,

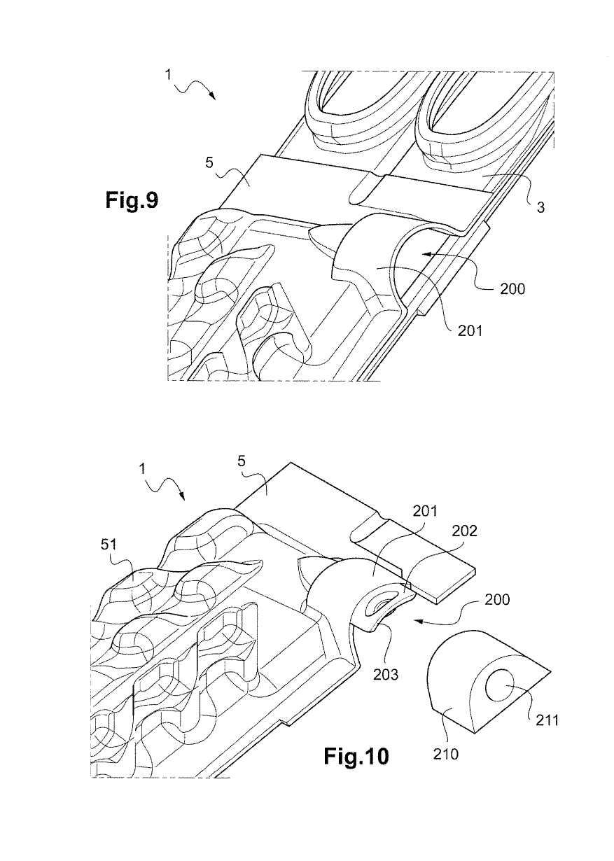

FIG. 9 shows a schematic perspective view of a filling duct of a tube with a reservoir of phase-change material,

FIG. 10 shows a schematic perspective and exploded view of a filling duct of a tube with a reservoir of phase-change material,

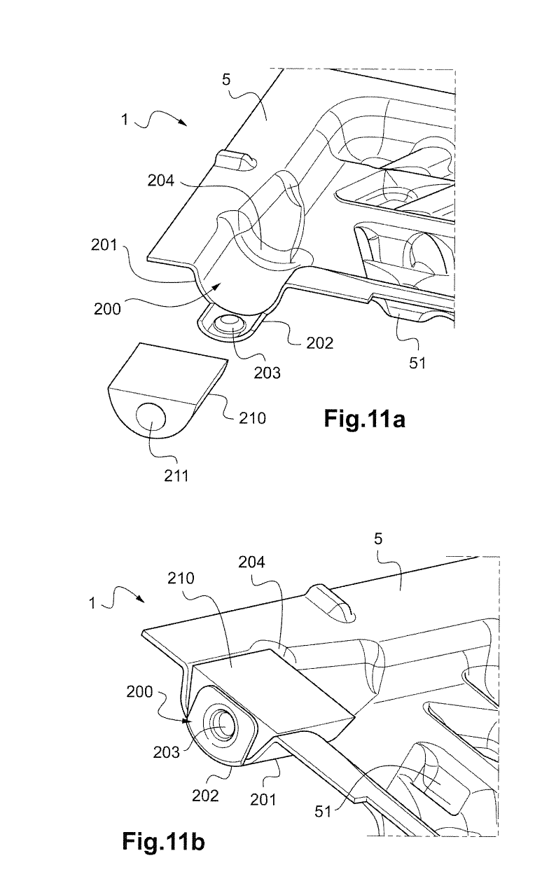

FIGS. 11a, 11b show schematic views in perspective and from above of a filling duct of a tube with a reservoir of phase-change material during different assembly steps.

In the various figures, identical elements bear the same reference numerals.

The following embodiments are examples. Whilst the description refers to one or more embodiments, this does not necessarily mean that each reference relates to the same embodiment or that the features apply only to one individual embodiment. Individual features of different embodiments may also be combined to provide further embodiments.

As FIG. 1 shows, the tube with a reservoir of phase-change material 1 comprises two flow plates 3 and at least one reservoir plate 5. The two flow plates 3 are configured to be assembled with one another in a sealed manner and to form at least one conduit 31 in which a first heat transfer fluid flows between said flow plates 3. The two flow plates 3 are preferably identical and attached to one another in a “mirror-symmetrical” manner which makes it possible that only one type of flow plate 3 has to be produced and thus permits savings to be made during production.

The at least one reservoir plate 5, in turn, comprises cavities 51 and is configured to be assembled in a sealed manner onto an external face of one of the two flow plates 3 so as to close the cavities 51 and to form housings of the phase-change material. These cavities 51 protrude over the external face of the reservoir plate 5 so that a second heat transfer fluid, for example an airflow, is able to flow between said cavities 51.

In order to produce the tube with a reservoir of phase-change material 1, only two different types of plate are used, namely two flow plates 3 and at least one reservoir plate 5. Such a design makes it possible to limit the production of such a tube with a reservoir to these two types of plates, thus making savings in production costs. Moreover, the assembly is simplified by this reduced number of types of plate.

An additional advantage of the tube with a reservoir of phase-change material 1 is that the phase-change material is directly in contact with the flow plate 3 which facilitates and improves the exchanges of calorific energy between the first heat transfer fluid and the phase-change material.

As FIGS. 1, 4 and 5 show, the flow plates 3 may also comprise hollows 32 which are preferably produced by stamping according to a uniform distribution over the entire flow plate 3. The flow plates 3 comprise an external face designed to be oriented either toward a reservoir plate 5 or an element for heat exchange with the second heat transfer fluid, such as a corrugated plate. Each flow plate 3 comprises an internal face opposing the external face from which each hollow 32 extends such that the top part thereof is in contact with the adjacent flow plate 3. According to an embodiment which is preferred but not limiting, the hollows 32 are distributed in a staggered manner on the flow plate 3. Due to such a distribution, the internal face of each hollow 32 is located in the flow path of the first fluid delimited by the conduit 31, whilst the external face may form a local store of phase-change material, thus increasing the heat exchange thereof.

Since the external face of the flow plate 3 is provided with hollows 32, said hollows form complementary reserves of phase-change material such that, for a given space requirement, a tube with a reservoir 5 of phase-change material provided with such hollows 32 permits a greater storage of phase-change material. This has the effect of increasing the time during which the phase-change material exchanges calorific energy with the second fluid.

Moreover, taking account of the fact that the hollows form additional connections with the adjacent flow plate 3, the mechanical strength of the tube with a reservoir of phase-change material 1 is increased. As a result, such a tube with a reservoir of phase-change material 1 may be used in a heat exchanger of the type comprising an evaporator which is capable of receiving a coolant, the pressure thereof having a nominal value of approximately 15 bar.

As FIG. 2 shows, the tube with a reservoir of phase-change material 1 comprises a single reservoir plate 5 on one of its external faces in contact with the second heat transfer fluid. The other of its faces is in contact, via a corrugated heat exchange plate, with the second heat transfer fluid, such a corrugated plate being sometimes described as a fin or insert.

According to one variant, however, the tube 1 may comprise a reservoir plate with a reservoir of phase-change material 1 on each of its external faces in contact with the second heat transfer fluid, as is shown in FIG. 3. In order to facilitate the filling of the protruding cavities 51 in this embodiment, the tube with a reservoir of phase-change material 1 may comprise a common filling orifice (not shown) for the protruding cavities 51 of the two reservoir plates 5.

According to a first embodiment illustrated in FIG. 4, the protruding cavities 51 are dome-shaped. These domes are more particularly arranged in a staggered manner so that the second heat transfer fluid is able to flow therebetween.

According to a second embodiment illustrated in FIG. 5, the protruding cavities 51 have an oblong shape. The protruding cavities 51 are thus distributed in a “V” shape relative to the longitudinal axis A of the reservoir plate 5 as FIG. 6 shows. This shape and this particular distribution permit the tube with a reservoir of phase-change material 1 to contain a greater quantity of phase-change material than in the case of a dome shape and also permit the losses of pressure of the second heat transfer fluid to be limited during its passage between the protruding cavities 51.

The protruding cavities 51, whether according to the first or the second embodiment, have a flat top portion 55, respectively of cylindrical section and polygonal section, for example approximately trapezoidal.

Such top portions 55 are designed to come into contact with a heat exchange tube 30 arranged opposite inside the heat exchange bundle 100, as shown in FIG. 7.

The exchange tube 30 may be a tube provided with micro-channels, such a tube being formed by the superposition of planar plates and a corrugated plate, said corrugated plate being sometimes described as an internal insert, and said corrugated plate thus being arranged between the two adjacent planar plates in order to form the micro-channels.

According to one variant, the exchange tube 30 may more particularly be composed of two flow plates 3, as have been described above, assembled together in a sealed manner.

FIG. 8 shows a heat exchange bundle 100 comprising tubes with a reservoir of phase-exchange material 1 in order to form ultimately a heat exchanger. The heat exchanger bundle 100 in this case, distributed over its entire length, comprises three tubes with a reservoir of phase-change material 1. Two of these tubes with a reservoir of phase-change material 1 comprise a reservoir plate 5 on each of their external faces in contact with the second heat transfer fluid. The third tube with a reservoir of phase-change material 1, in turn, only comprises a single reservoir plate 5 on one of its external faces in contact with the second heat transfer fluid. The total number of tubes with a reservoir of phase-change material 1 and reservoir plates 5 present inside a heat exchange bundle 100 depends on the size and length thereof. The longer the heat exchange bundle 100, the greater the number, in order to ensure a continuous cooling of the second heat transfer fluid and this is the case even if the first heat transfer fluid no longer circulates in said bundle, for example when the compressor is stopped.

Thus it is seen clearly that the tube with a reservoir of phase-change material 1 permits simple assembly and inexpensive manufacture, since it is composed of two flow plates 3 and at least one reservoir plate 5. Moreover, the phase-change material is directly in contact with the flow plate 3 which facilitates and improves the exchanges of calorific energy between the first heat transfer fluid and the phase-change material.

In order to introduce the phase-change material into the tube with a reservoir of phase-change material 1, said tube further comprises a filling duct 200, as illustrated in FIGS. 9 to 11b.

For improved comprehension and illustration, only the reservoir plate 5 is shown in FIGS. 10, 11a and 11b.

One end of said filling duct 200 opens into one of the edges of said tube with a reservoir of phase-change material 1 so as to be accessible when the tube with a reservoir of phase-change material 1 is incorporated inside a heat exchange bundle 100.

The filling duct 200 is formed, on the one hand, by a filling spout 201 and, on the other hand, by the external face of one of the two flow plates 3. The filling duct 200 further comprises a plug 210 which closes said duct and prevents the phase-change material from escaping through said filling duct 200.

The filling duct 200 and the plug 210 are contained within a volume of width smaller than or equal to the width of the tube with a reservoir of phase-change material 1 and of height less than or equal to the height of the housings of the phase-change material, in particular the cavities 51. As a result, the filling duct 200 does not exceed in terms of width or height the tube with a reservoir of phase-change material 1. Thus when said tube with a reservoir of a phase-change material 1 is incorporated inside a heat exchange bundle 100, the filling duct 200 does not protrude and is not an encumbrance.

Inside the heat exchange bundle 100 it is also advantageous to place the tubes with a reservoir of phase-change material 1 so that the filling duct 200 is located in the top position, i.e. furthest away from the ground. In this manner, the filling thereof will be facilitated and the risk of leakage in the region of said filling duct 200 will be lower.

The flow plates 3 and the reservoir plate 5 are preferably produced in metal and are obtained by stamping. The filling spout 201 of the reservoir plate 5 may thus also be produced during the stamping of said reservoir plate 5. The different plates may thus be fixed together by brazing, for example.

In order to ensure effective fixing and a good seal, the tube with a reservoir of phase-change material 1 may comprise a filling and sealing compound between the filling spout 201 of the reservoir plate 5 and the plug 210.

The filling duct 200, and more specifically the filling spout 201, advantageously comprises a stop 204 in the interior thereof. This stop 204 blocks the plug 210 which is not able to move further into the interior of the filling duct 200. The plug 210 preferably has a length which is less than or equal to the distance between the end of the filling duct 200 and the stop 204, such that said plug 210 does not protrude beyond said filling duct 200.

The plug 210 may be produced, for example, in metal. As a result, said metal plug 210 may be fixed by brazing during the step when the flow plates 3 and the reservoir plate 5 are fixed together by brazing.

The plug 210 may also be produced in elastomer or plastics material. In this case, said plug 210 may, for example, be of greater size than that of the filling duct 200 such that said plug 210 is compressed inside the filling duct 200. Due to this compression, the seal in the region of the filling duct 200 is ensured. In the case where the plug 210 is made of elastomer or plastics material, this material is preferably inserted into the filling duct 200 after fixing the flow plates 3 and the reservoir plate 5 together by brazing.

In order to maintain the plug 210 inside the filling duct 200, said filling duct 200 may comprise a retention tongue 202 as illustrated in FIGS. 10 to 11b. The retention tongue 202 is folded back onto the end of said filling duct 200 opening into one of the edges of the tube with a reservoir of phase-change material 1. The plug 210 is thus blocked between the stop 205 and the retention tongue 202 as FIG. 11b shows.

Preferably, the retention tongue 202 is made of the same material as the reservoir plate 5 and may thus be produced at the same time as said reservoir plate 5, for example by stamping.

The plug 210 may also comprise a filling orifice 211 as illustrated in FIGS. 10 to 11c. This filling orifice 211 permits, in particular, the insertion of phase-change material into the tube with a reservoir of phase-change material 1 whilst the plug 210 is already in place and fixed.

When the plug 211 does not have a filling orifice 211, the phase-change material is, for example, inserted into the tube with a reservoir of phase-change material 1 before the positioning of the plug 210, in particular when said plug is made of metal. When the plug 210 is made of elastomer or plastics material, the phase-change material may be inserted via a needle passing through the plug 210, the elastic properties of the elastomer or plastics material permitting the space created to be closed when the needle is removed, and the plug thus preserving its seal.

When the plug 211 has a filling orifice 211, the phase-change material may be inserted into the tube with a reservoir of phase-change material 1 via said filling orifice 211, after positioning and fixing the plug 210.

The retention tongue 202 when it is folded back, advantageously covers the filling orifice 211 of the plug 210. The retention tongue 202 thus closes the filling orifice 211. To ensure an improved closure and seal, the retention tongue 202 may comprise a projection 203 designed to be inserted at least partially into the filling orifice 211 of the plug 210 when said retention tongue 202 is folded back.

Thus it is clear that due to the presence of the filling duct 200, the filling of the tube with a reservoir of phase-change material 1 made of phase-change material is simple and easy to implement.

Moreover, the limited number of components permits production costs to be restricted.

1. A tube with a reservoir of phase-change material for a heat exchange bundle of a heat exchanger, said tube with a reservoir of phase-change material comprising:
two flow plates configured to be assembled with one another in a sealed manner and to form at least one conduit in which a first heat transfer fluid flows;
at least one reservoir plate, said reservoir plate being configured to be assembled in a sealed manner onto an external face of one of the two flow plates so as to form housings for the phase-change material; and
a filling duct for the phase-change material, one end of said filling duct opening into one of the edges of said tube with a reservoir of phase-change material,
said filling duct being formed by a filling spout of the reservoir plate towards the outside and by the external face of one of the two flow plates,
said filling duct further comprising a plug, said filling duct and said plug being contained within a volume of width smaller than or equal to the width of the tube with a reservoir of phase-change material and of height less than or equal to the height of the housings of the phase-change material.

2. The tube with a reservoir of phase-change material as claimed in claim 1, wherein the filling duct comprises a stop.

3. The tube with a reservoir of phase-change material as claimed in claim 1, wherein the plug is produced in metal.

4. The tube with a reservoir of phase-change material as claimed in claim 3, wherein the flow plates and the reservoir plate are also made of metal and fixed together by brazing, said metal plug also being fixed during the brazing of said plates together.

5. The tube with a reservoir of phase-change material as claimed in claim 1, wherein the plug is produced in an elastomer or plastics material.

6. The tube with a reservoir of phase-change material as claimed in claim 5, wherein the plug is of a size greater than that of the filling duct so as to be compressed inside said filling duct.

7. The tube with a reservoir of phase-chase material as claimed in claim 1, wherein the filling duct comprises a retention tongue which is folded back onto the end of said filling duct opening into one of the edges of the tube with a reservoir of phase-change material.

8. The tube with a reservoir of phase-change material as claimed in claim 7, wherein the retention tongue is made of the same material as the reservoir plate.

9. The tube with a reservoir of phase-change material as claimed in claim 7, wherein the plug comprises a filling orifice.

10. The tube with a reservoir of phase-change material as claimed in claim 9, wherein, when folded back, the retention tongue covers the filling orifice of the plug.

11. The tube with a reservoir of phase-change material as claimed in claim 10, wherein the retention tongue comprises a projection to be inserted at least partially into the filling orifice of the plug when said retention tongue is folded back.

12. The tube with a reservoir of phase-change material as claimed in claim 1, further comprising a filling and sealing compound between the filling spout of the reservoir plate and the plug.
